(19) United States
(12) Patent Application Publication
(10) Pub. No.: US 2007/0024522 A1
(43) Pub. Date: Feb. 1, 2007

(54) Orientation adjustable RF connector

(76) Inventor: Jui-Yang Lee, Tainan Hsien (TW)

Correspondence Address: JUI-YANG LEE, P.O. BOX 90,, Tainan City, 70499, TW

(21) Appl. No.: 11/190,950

(22) Filed: Jul. 28, 2005

(51) Int. Cl. H01Q 1/50

(52) U.S. Cl. 343/906; 343/702

(57) ABSTRACT

An RF connector comprises a sleeve having a through hole; one end of the through hole being formed as a receiving groove and another end thereof being formed with a threaded section; one inner end of the receiving groove being formed with a stop edge; a connecting unit being inserted into the sleeve; the connecting unit being formed with a penetrating hole; an annular edge being formed at an outer side of the connecting unit; and a stop ring tightly engaged to the receiving groove of the sleeve. In another design, the through hole is formed as a receiving groove and inner wall thereof is formed with a threaded section; one inner end of the receiving groove being formed with a stop edge. When it is desired to adjust the orientation of the antenna, the sleeve is slightly released, and then the antenna is adjusted to a receiving orientation.

### FIELD OF THE INVENTION

The present invention relates to connectors, and in particular to an RF (radio frequency) connector, wherein the orientation of an antenna connected thereto can be adjusted precisely and the antenna can be positioned correctly. When adjusting the orientation and positioning of the antenna, it will not be interfered by the resisting force and twisting force of the spring. Furthermore, the connector of the present invention will not be affected by cool contraction and heat expansion. Moreover, in orientation adjustment of the antenna, the plastic material will not crack or wear or deform so as to affect the positioning of the antenna.

### BACKGROUND OF THE INVENTION

In general wireless receiving devices (such as telephones, TVs, AUDIOs, selectors, receivers, set top boxes, etc), a wireless antenna A is connected to a connector at a receiving terminal so that in use, the orientation of the antenna is adjustable to match the status of the environment.

Generally, the antenna A is structure to a main body of the receiving device through a connector 1 (referring to FIGS. 1, 2 and 3). The connector 1 is formed by a casing 10, a terminal 1 1, an elastic unit 12, and a ring 13. The casing 10 is installed with a resisting surface 100 and an inner thread 101. The terminal 11 is connected to the elastic unit 12 and then is assembled to the casing 10. At another end of the elastic unit 12 is tightly engaged to one side of the casing 10 through the ring 13. The elastic unit 12 is resisted between the resisting surface 100 of the casing 10 and the ring 13 by the elastic unit 12 for adjusting the receiving orientation of the antenna A so as to drive the terminal 11 and the elastic unit 12 to rotate and displace. However the prior art connector 1 has the following disadvantages.

When adjusting antenna A, since the adjusting angle will make the receiving signals stable, the connector 1 must has the function for adjusting angles. Thus the connector has resisting forces and twisting forces for rotation and positioning, which is achieved by the elastic unit 12 (for example, springs or elastic sheets). However this will induce error in assembly so that the resisting force and twisting force is unstable, especially if the prior art connector 1 is formed by spring. This is because the burden of the spring is not uniform and the cross section of the spring is not at the same horizontal surface.

Furthermore, the prior art structure is deeply affected by the heat expansion and cool contraction. As a result, it is possible that the material is changed and the device cannot well operate.

When the orientation of the antenna A is adjusted, the terminal 11 and the elastic unit 12 will be driven. In rotation, the elastic unit 12 will damage the resisting surface 100 of the casing 10 so that the resisting surf ace 100 is worn, cracked or deforms. As a result, the tightness of the whole structure will deteriorate. The positioning of the antenna A become worse.

During rotation, if the elastic unit 12 cracks the resisting surface 100 of the casing 10, the elastic unit 12 will embed into the resisting surface 100 of the casing 10 so that the orientation of the casing 10 cannot be adjusted.

If the elastic unit 12 is compressed frequently, the elastic unit 12 will have elastic fatigue so that the orientation of the connector 1 is not adjustable.

### SUMMARY OF THE INVENTION

Accordingly, the primary object of the present invention is to provide an RF connector, wherein the orientation of an antenna connected thereto can be adjusted precisely and the antenna can be positioned correctly. When adjusting the orientation and positioning of the antenna, it will not be interfered by the resisting force and twisting force of the spring. Furthermore, the connector of the present invention will not be affected by cool contraction and heat expansion. Moreover, in orientation adjustment of the antenna, the plastic material will not crack or wear or deform so as to affect the positioning of the antenna.

To achieve above objects, the present invention provides an RF connector. The connector comprises a sleeve having a through hole; one end of the through hole being formed as a receiving groove and another end thereof is formed with a threaded section; one inner end of the receiving groove being formed with a stop edge; a connecting unit being inserted into the sleeve; the connecting unit being formed with a penetrating hole; an annular edge being formed at an outer side of the connecting unit; and a stop ring tightly engaged to the receiving groove of the sleeve. In another design, the through hole is formed as a receiving groove and inner wall thereof is formed with a threaded section; one inner end of the receiving groove being formed with a stop edge. When it is desired to adjust the orientation of the antenna, the sleeve is slightly released, and then the antenna is adjusted to a receiving orientation.

The various objects and advantages of the present invention will be more readily understood from the following detailed description when read in conjunction with the appended drawing.

### BRIEF DESCRIPTION OF THE DRAWINGS

FIG. 1 is an exploded perspective view of a prior art connector.

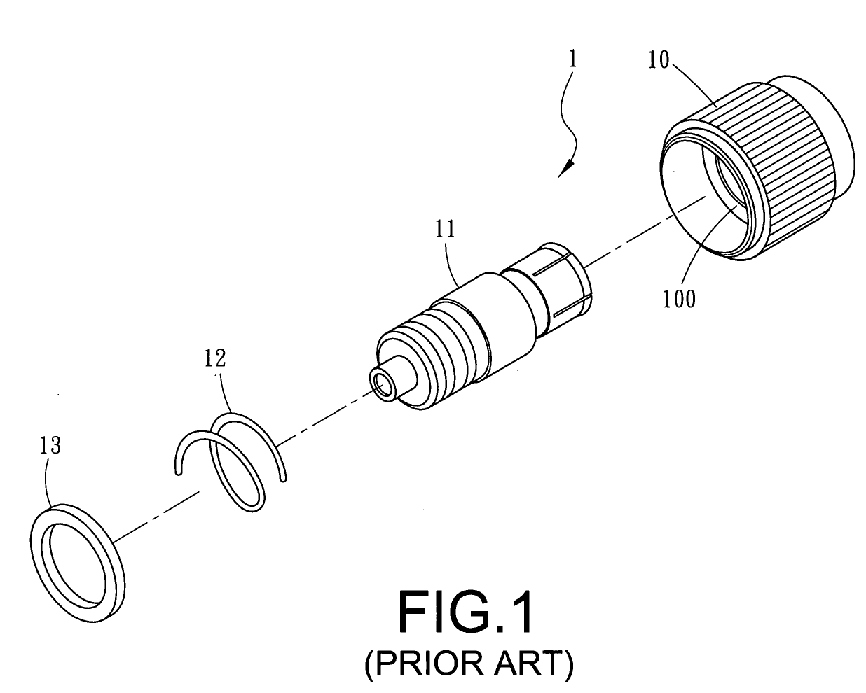

FIG. 2 is an assembled schematic view about the prior art connector.

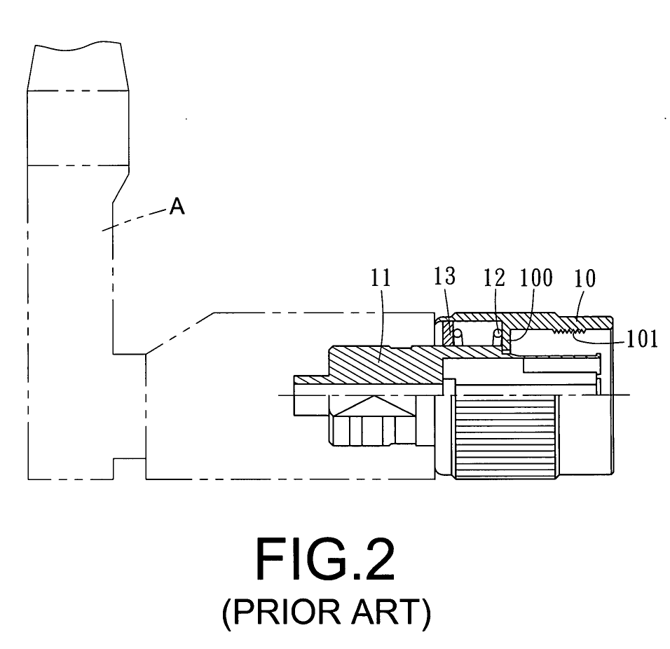

FIG. 3 is an exploded perspective view about the first embodiment of the present invention.

FIG. 4 shows a schematic view about the assembly of the present invention to a joint.

FIG. 5 is an assembled schematic view of the FIG. 4.

FIG. 6 is an exploded perspective view of the second embodiment of the present invention.

FIG. 7 is assembled cross sectional view about the second embodiment of the present invention.

### DETAILED DESCRIPTION OF THE INVENTION

In order that those skilled in the art can further understand the present invention, a description will be described in the following in details. However, these descriptions and the appended drawings are only used to cause those skilled in the art to under stand the objects, features, and characteristics of the present invention, but not to be used to confine the scope and spirit of the present invention defined in the appended claims.

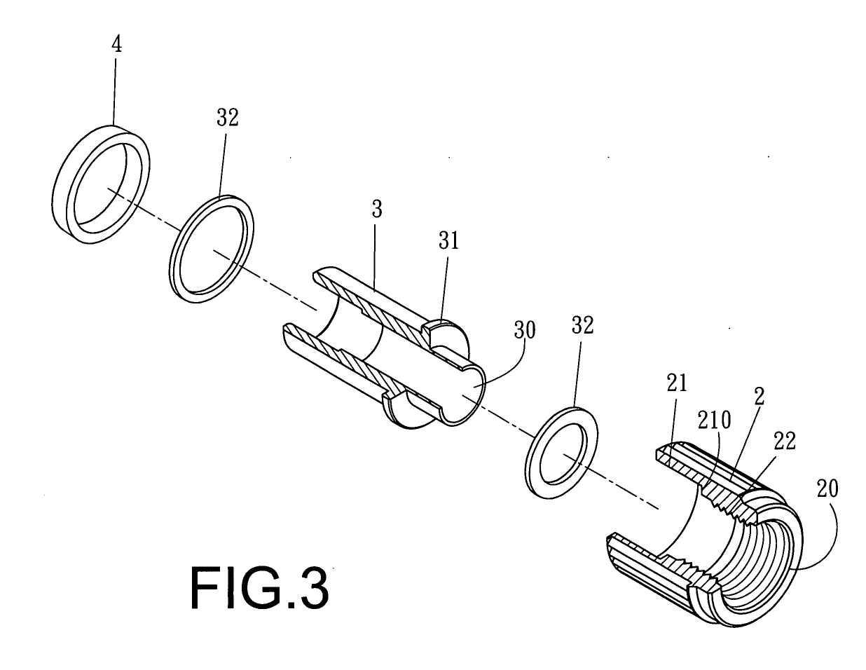

Referring to FIG. 3, the present invention has the following elements.

A sleeve 2 has a through hole 20. One end of the sleeve 2 is formed as a receiving groove 21 and another end thereof is formed with a threaded section 22 at an inner side thereof. One end of the receiving groove 21 is formed with a stop edge 210.

A connecting unit 3 is inserted into the sleeve 2. The connecting unit 3 is formed with a penetrating hole 30. An annular edge 31 is formed at an outer side of the connecting unit 3. Two sides of the annular edge 31 are engaged with respective washers 32.

A metal stop ring 4 is tightly engaged to the receiving groove 21 of the sleeve 2. An outer diameter of the stop ring 4 is slightly larger than an inner diameter of the receiving groove 21 of the sleeve 2 so that the stop ring 4 is tightly engaged to the sleeve 2.

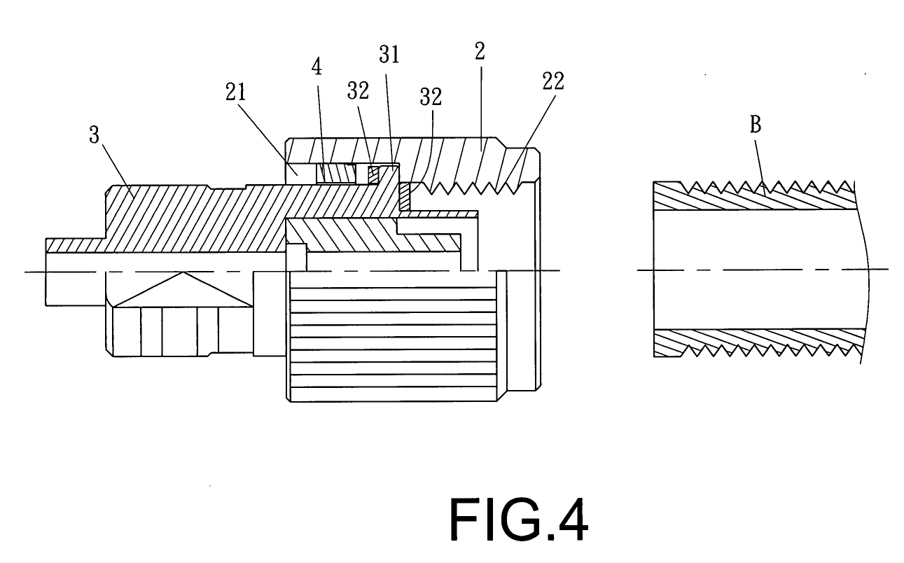

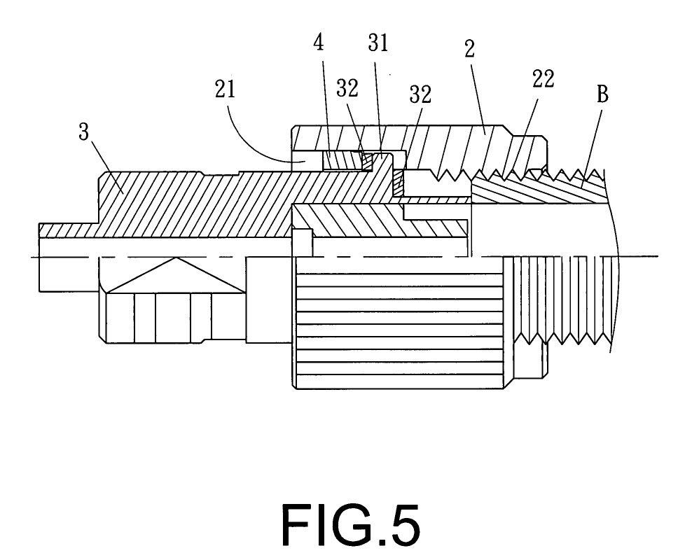

In assembly, referring to FIGS. 3 to 5, the two washers 32 are engaged to the two sides of the annular edge 31. Then the stop ring 4 is tightly engaged to one side of the receiving groove 21 of the sleeve 2 to be firmly secured therein. Thereby the connecting unit 3 is slideably connected to the sleeve 2. Two sides of the connector formed by this way are connected to an antenna A and a joint B of a receiving device. When it is desired to adjust the orientation of the antenna A, it only needs to slightly release the sleeve 2, and then the antenna A is adjusted to a preferred receiving orientation. Then the sleeve 2 is tightened so as to tightly resist position the connecting unit 3 and then the orientation of the antenna is fixed.

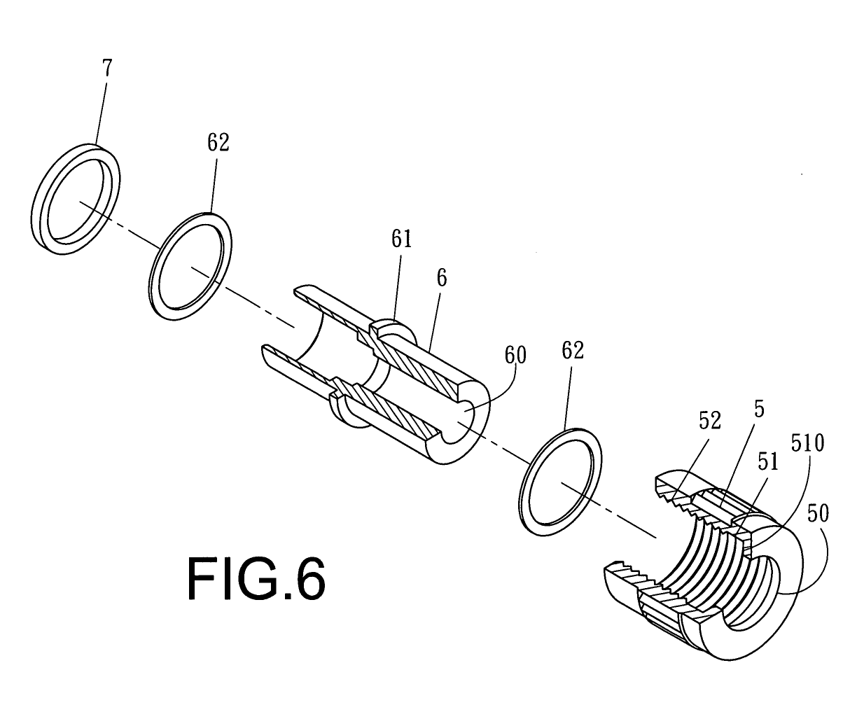

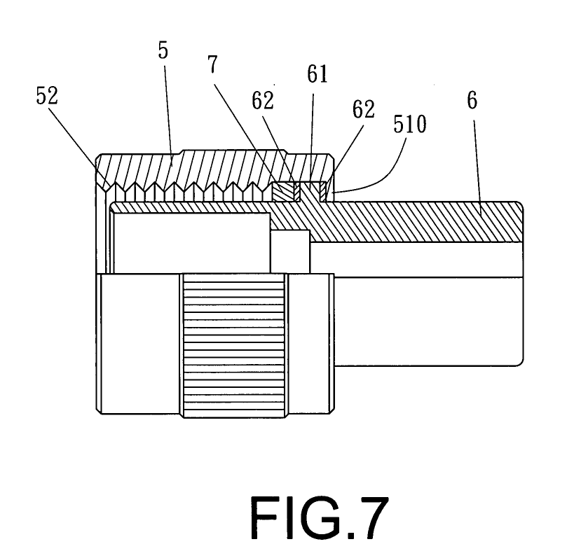

Referring to FIGS. 6 to 7, the second embodiment of the present invention is illustrated.

A sleeve 5 has a through hole 50. The through hole 50 is formed as a receiving groove 51 and an inner wall of the receiving groove 51 is formed with a threaded section 52. One end of the receiving groove 51 is formed with a stop edge 510.

A connecting unit 6 is inserted into the sleeve 6. The connecting unit 6 is formed with a penetrating hole 60. An annular edge 61 is formed at an outer side of the connecting unit 6. Two sides of the annular edge 61 are engaged with respective washers 62.

A stop ring 4 is tightly engaged to the receiving groove 51 of the sleeve 5. An outer diameter of the stop ring 5 is slightly larger than an inner diameter of the receiving groove 51 of the sleeve 5 so that the stop ring 7 is tightly engaged to the sleeve 5.

After assembly above structure, a connector is formed. Two sides of the connector serve to connect an antenna A and a joint of a receiving device which may have different specification. When it is desired to adjust the orientation of the antenna A, it only needs to slightly release the sleeve 5, and then the antenna A is adjusted to a preferred receiving orientation. Then the sleeve 5 is tightened so as to tightly resist position the stop ring 7 and then the orientation of the antenna is fixed.

Advantages of the present invention will be described herein. When adjusting the orientation and positioning of the antenna, it will not be interfered by the resisting force and twisting force of the spring. Furthermore, the connector of the present invention will not be affected by cool contraction and heat expansion. Moreover, in orientation adjustment of the antenna, the plastic material will not crack or wear or deform so as to affect the positioning of the antenna.

The present invention is thus described, it will be obvious that the same may be varied in many ways. Such variations are not to be regarded as a departure from the spirit and scope of the present invent ion, and all such modifications as would be obvious to one skilled in the art are intended to be included within the scope of the following claims.

What is claimed is:

1. An RF connector comprising:
a sleeve having a through hole; one end of the through hole being formed as a receiving groove and another end thereof being formed with a threaded section; one inner end of the receiving groove being formed with a stop edge;
a connecting unit being inserted into the sleeve; the connecting unit being formed with a penetrating hole; an annular edge being formed at an outer side of the connecting unit; and
a stop ring tightly engaged to the receiving groove of the sleeve; and
wherein by assembling above components, two sides of the connector serves to connect an antenna and a joint of a receiving device, when it is desired to adjust the orientation of the antenna, it only needs to slightly release the sleeve, and then the antenna is adjusted to a receiving orientation; and then the sleeve is tightened so as to tightly resist against the connecting unit and then the orientation of the antenna is fixed.

2. The RF connector as claimed in claim 1, wherein the two sides of the annular edge are engaged with respective washers.

3. The RF connector as claimed in claim 1, wherein an outer diameter of the stop ring is slightly larger than an inner diameter of the receiving groove of the sleeve so that the stop ring is tightly engaged to the sleeve.

4. An RF connector comprising:
a sleeve having a through hole; the through hole being formed as a receiving groove and inner wall of the through hole being formed with a threaded section; one inner end of the receiving groove being formed with a stop edge;
a connecting unit being inserted into the sleeve; the connecting unit being formed with a penetrating hole; an annular edge being formed at an outer side of the connecting unit; and
a stop ring tightly engaged to the receiving groove of the sleeve; and
wherein by assembling above components, two sides of the connector serve to connect an antenna and a joint of a receiving device, when it is desired to adjust the orientation of the antenna, it only needs to slightly release the sleeve, and then the antenna is adjusted to a receiving orientation; then the sleeve is tightened so as to tightly resist against the connecting unit and then the orientation of the antenna is fixed.

5. The RF connector as claimed in claim 4, wherein the two sides of the annular edge being engaged with respective washers.

6. The RF connector as claimed in claim 4, wherein an outer diameter of the stop ring is slightly larger than an inner diameter of the receiving groove of the sleeve so that the stop ring is tightly engaged to the sleeve.
